(19) United States
(12) Patent Application Publication
(10) Pub. No.: US 2015/0345711 A1
(43) Pub. Date: Dec. 3, 2015

(54) Surge-Based Flow Isolation System

(71) Applicant: Charles Shepherd, Jefferson, GA (US)

(72) Inventor: Charles Shepherd, Jefferson, GA (US)

(21) Appl. No.: 14/723,292

(22) Filed: May 27, 2015

Related U.S. Application Data
(60) Provisional application No. 62/004,523, filed on May 29, 2014.

(51) Int. Cl. F17D 5/02; F17D 3/01

(52) U.S. Cl. CPC F17D 5/02; F17D 3/01

(57) ABSTRACT

An exemplary surge-based flow isolation system embodiment comprises a surge detection component, an automated isolation valve and a controller communicatively coupled to both. When the surge detection component senses a substantial change in a monitored variable associated with a fluid in a pipe, a signal is sent to the controller that, in turn, instructs the valve to isolate the flow. It is envisioned that the variable may be, but is not limited to being, flow rate or pressure. Advantageously, a surge-based flow isolation system may be able to shut off a supply pipe, such as a water supply pipe servicing a house, in the event that the pipe ruptures due to a freezing ambient environment.

### BACKGROUND

The present invention relates to flow isolation systems and, more particularly, to a surge-based flow isolation system for isolating a residential water supply line in the event of a pipe rupture. As one of ordinary skill in the art would recognize, freezing temperatures may cause a water supply line to rupture, thereby leading to potentially costly water damage.

Therefore, what is needed in the art is a flow isolation system that automatically shuts off a water supply line in the event of a rupture. More specifically, what is need in the art is a flow isolation system that senses a sudden drop in pressure or surge in flow rate and reacts by isolating the flow.

### BRIEF SUMMARY OF THE INVENTION

Various embodiments, aspects and features of the present invention encompass a surge-based flow isolation system that is operable to isolate a fluid flow in a pipe in the event of a sudden increase or surge in the fluid flow. An exemplary embodiment of the system comprises an electrically actuated solenoid valve, a switch controller and a surge detection instrument. When the surge detection instrument senses a surge in flow in the pipe, an electrical signal is generated that triggers the switch controller to actuated the solenoid valve which, in turn, isolates the fluid flow in the pipe.

### DESCRIPTION OF THE DRAWINGS

FIG. 1 features an exemplary embodiment of a surge-based flow isolation system according to the proposed solution; and

FIG. 2 is a schematic of the exemplary embodiment featured in FIG. 1.

### DESCRIPTION

The Figures and the related description are offered for illustrative purposes and depict one exemplary embodiment of a surge-based flow isolation system. As such, the exemplary embodiment shown in the Figures does not illustrate all features and aspects that may be included in a given embodiment of a surge-based flow isolation system. For instance, it is envisioned that a surge-based flow isolation system may include an automated ball valve or automated gate valve, for instance, in place of the depicted solenoid valve. Further, it is envisioned that the surge sensor may detect a sudden increase in flow based on a change in flow or based on a change in pressure, depending on embodiment.

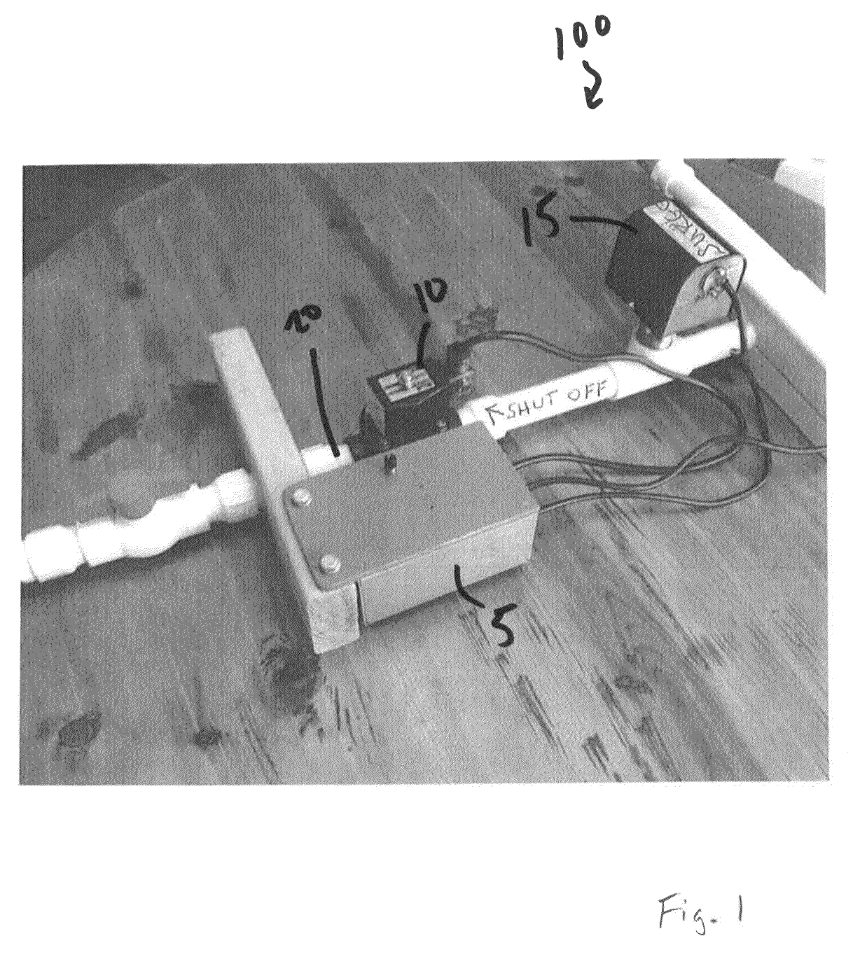

FIG. 1 features an exemplary embodiment of a surge-based flow isolation system 100 according to the proposed solution. As can be seen in the FIG. 1 embodiment, a controller or switch box 5 is electrically connected to a solenoid valve 10 that is mounted in pipe 20. Surge detection instrument 15 is also mounted in pipe 20 and electrically connected to switch box 5. The surge detection instrument is operable to sense a sudden change in flow in the pipe 20, such as may occur in the event that pipe 20 ruptures due to freezing somewhere downstream of the system 100. It is envisioned that the surge detection instrument 15 may detect a sudden surge based on an increase in flow rate beyond an expected flow rate that may be attributable to normal use of fixtures within a house or structure supplied by pipe 20. It is also envisioned that the surge detection instrument 15 may detect a sudden surge based on a decrease in pressure beyond an expected decrease in pressure that may be attributable to normal use of fixtures within a house or structure supplied by pipe 20.

When a surge is detected by surge detection instrument 15 that indicates a catastrophic rupture condition in pipe 20, the surge detection instrument 15 may provide an electrical signal (or break an existing electrical signal) to switch box 5. In turn, switch box 5 may provide an electrical signal (or break an existing electrical signal) to solenoid valve 10, thereby causing solenoid valve 10 to actuate and shut off fluid flow in pipe 20. In this way, an embodiment of a surge-based flow isolation system may mitigate water damage to a structure such as could occur in the event that pipe 20 freezes and ruptures.

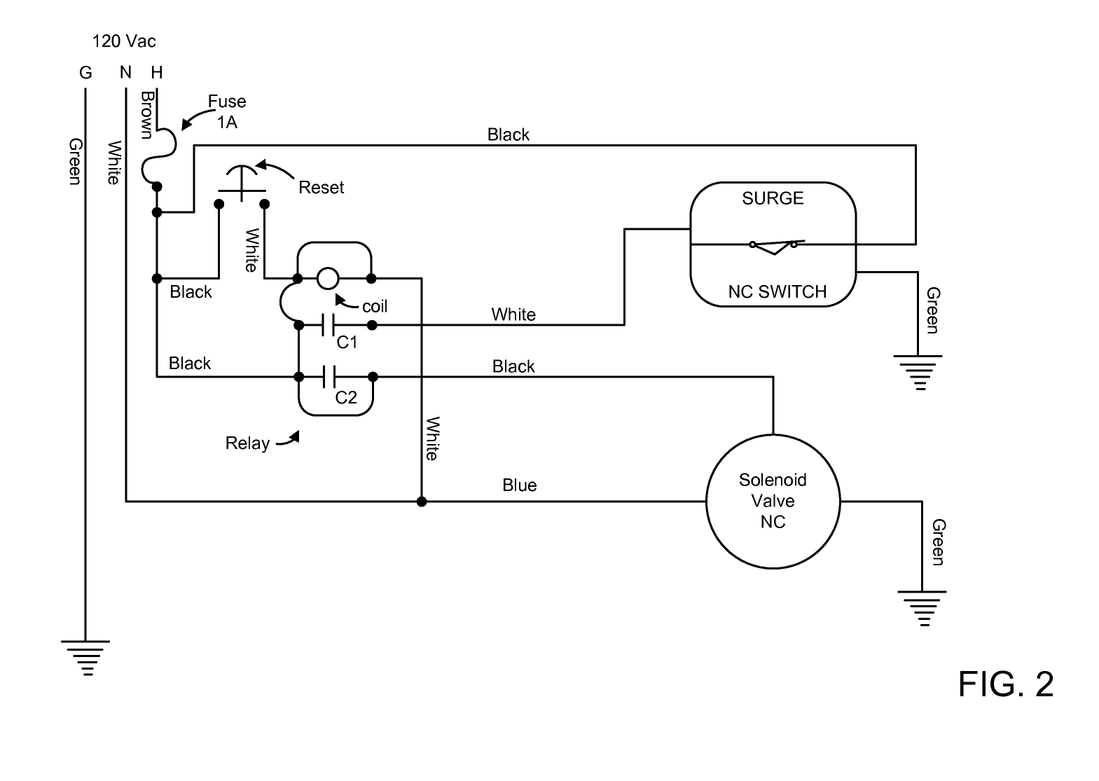

FIG. 2 is a schematic of the exemplary embodiment featured in FIG. 1.

What is claimed is:

1. A flow isolation system, comprising:
a surge detection component communicatively coupled to a pipe;
a valve positioned in the pipe and configured to isolate a flow of fluid in the pipe; and
a controller communicatively coupled to the surge detection component and the valve;
wherein, when the surge detection component senses a substantial change in a monitored variable associated with the fluid, the controller causes the valve to actuate and isolate the flow.

2. The system of claim 1, wherein the monitored variable is flow rate and the substantial change is an increase in the flow rate.

3. The system of claim 1, wherein the monitored variable is pressure and the substantial change is a decrease in pressure.
